(19) United States
(12) Patent Application Publication
(10) Pub. No.: US 2008/0288363 A1
(43) Pub. Date: Nov. 20, 2008

(54) Recording medium, information processing system and information processing method

(76) Inventors: Masatoshi Ueno, Kanagawa (JP); Akihiro Kikuchi, Chiba (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(21) Appl. No.: 11/903,650

(22) Filed: Sep. 24, 2007

(30) Foreign Application Priority Data
Oct. 11, 2006 (JP) 2006-277918

(51) Int. Cl. G06Q 30/00; G06K 19/06

(52) U.S. Cl. 705/26; 235/492

(57) ABSTRACT

An information processing system processes commodity order acceptance information generated in an online store. The system includes: a recording medium for a charging process for settling a charge imposed on purchase or lending of a commodity from an online store; a recording apparatus for recording delivery destination information indicative of a delivery destination of the commodity into the recording medium; a reading apparatus for reading the delivery destination information from the recording medium; and an information processing apparatus for commodity order acceptance connected to the reading apparatus, accepting an order or selection of the commodity, generating commodity order acceptance information. The information processing apparatus notifies an information processing apparatus for commodity order acceptance and delivery of commodity order acceptance information by which the delivery destination information read by the reading apparatus and commodity selection information obtained by order acceptance or commodity selection are associated with each other.

### CROSS REFERENCES TO RELATED APPLICATIONS

The present invention contains subject matter related to Japanese Patent Application JP 2006-277918, filed in the Japan Patent Office on Oct. 11, 2006, the entire contents of which being incorporated herein by reference.

### BACKGROUND OF THE INVENTION

1. Field of the Invention

This invention relates to a recording medium, an information processing system and an information processing method which can be applied to an electronic money card utilization system wherein the destination of delivery of a commodity is limited, an electronic money card gift-giving system wherein the destination of delivery of a gift is limited, an electronic money card utilization system wherein the destination of delivery of a rental commodity is limited or a like system.

2. Description of the Related Art

In recent years, thanks to development of communication systems of the Internet and so forth in the information processing field, electronic commerce which utilizes a network has become and is becoming animated. In electronic commerce, trade or transaction is performed through a network between and by a person (hereinafter referred to as information distributor) who supplies or provides commodities, services or the like and a person (hereinafter referred to as information user) who purchases or utilizes such commodities, services and so forth.

As a system for such electronic commerce, a network shopping system is known. The network shopping system provides a service of selling commodities desired by a user in an online store open on the Internet. In the network shopping system, an online store is opened using a terminal apparatus connected to the Internet, and when a user tries to purchase a commodity, the user uses an inputting apparatus such as a keyboard and/or a mouse to input delivery destination information of the commodity. At this time, the terminal apparatus displays a screen image for inputting to urge the user to perform inputting so that the user inputs its address, name, telephone number and so forth. Based on the input information, a web server connected to the terminal apparatus acquires delivery destination information.

Further, in order to reduce the time and labor required by a plural number of times of inputting operation, such personal information as the address, name and telephone number is stored into the terminal apparatus used for the inputting or a membership registration function of an online store is utilized to store such personal information by the online store side. Where the system is configured in this manner, since the personal information can be recalled later, the time and labor for inputting can be reduced.

In connection with a network shopping system of the type described, a content delivery system, a center server, a user terminal apparatus, a mobile authentication apparatus, a computer program, a recording medium and a content delivery method by the center server are disclosed in Japanese Patent Laid-Open No. 2004-72423 (page 10, FIG. 1) (hereinafter referred to as Patent Document 1). The content delivery system includes an encryption server, a content delivery server, a settlement server and a license authentication server. The encryption server produces content key data unique to each content and encrypts content data with the content key data. The content delivery server distributes the encrypted content data to a user terminal apparatus in response to a delivery request. The settlement server cooperates with the mobile authentication apparatus to execute settlement corresponding to the delivery of the content key data. The license authentication server produces encrypted content key data based on personal key data. Where the system is configured in this manner, data for decrypting the encrypted content data can be distributed on the real time basis with a high degree of security.

### SUMMARY OF THE INVENTION

Such network shopping systems as described above have the following problems.

i. If it is tried to apply such a content delivery system as disclosed in Patent Document 1 to a network shopping system to construct a system by which a commodity is purchased from an online store, then a commodity purchasing person itself must input the address of its home. This makes an inputting operation cumbersome.

ii. Where such a mobile authentication function as disclosed in Patent Document 1 is applied to a network shopping system, since personal information is stored into an Internet-connectable terminal apparatus, the personal information can be shared also by another terminal apparatus.

iii. Further, since it is unclear to an information user where personal information is stored, if a data file in which the personal information is recorded is carried through a medium or a medium is used indiscreetly on a public Internet-connectable terminal apparatus in an Internet cafe or the like, then there is the possibility that the data file in which the personal information is recorded may be left or leak without being deleted from the public terminal apparatus.

iv. Further, where a membership registration function of an online store is utilized and the system is not shared between a plurality of online stores, membership registration must be performed for each online store.

v. Even if the system is shared, it is necessary for a user to input a user ID and/or a password. However, where the terminal apparatus which can be used with the system is not a terminal apparatus which includes a keyboard such as a personal computer (PC) but a terminal apparatus whose inputting apparatus is restricted to a remote controller as in the case of a television receiver, significant time and labor are required to input a user ID and a password.

Therefore, it is demanded to provide a recording medium, an information processing system and an information processing method which make it possible, when a commodity purchasing person tries to purchase a commodity from an online store or in a like case, to eliminate such an operation by the commodity purchasing person itself of inputting the address of its home and to reduce the inputting operation to an inputting operation of passing or holding the card through or over a reading apparatus or the like.

According to an embodiment of the present invention, there is provided a recording medium for a charging process for settling a charge imposed on purchase or lending of a commodity, wherein the recording medium has recorded thereon delivery destination information which indicates a delivery destination of the commodity and is read from the recording medium when the commodity is purchased or rented.

In the recording medium, delivery destination information which indicates a delivery destination of a commodity is recorded. Then, when the commodity is purchased or rented, the delivery destination information is read from the recording medium.

With the recording medium, when a commodity is purchased or rented from an online store, an operation by a commodity purchasing person or the like of inputting an address of its home can be omitted. Consequently, the necessary operation can be reduced to an operation of passing or holding up the recording medium through or over a reading apparatus or the like. Besides, a commodity delivery center can deliver the commodity to the delivery destination based on the delivery destination information added to the commodity order acceptance information.

According to another embodiment of the present invention, there is provided an information processing system for processing commodity order acceptance information generated in an online store from which a commodity is to be purchased or lent through a communication system. The system includes a recording medium for a charging process configured to settle a charge imposed on purchase or lending of the commodity, a recording apparatus configured to record delivery destination information indicative of a delivery destination of the commodity into the recording medium, a reading apparatus configured to read the delivery destination information from the recording medium, and an information processing apparatus for commodity order acceptance connected to the reading apparatus and configured to accept an order or selection of the commodity, the information processing apparatus notifying an information processing apparatus for commodity order acceptance and delivery of commodity order acceptance information by which the delivery destination information read by the reading apparatus and commodity selection information obtained by the acceptance of the order or selection of the commodity are associated with each other.

In the information processing system, the recording apparatus records delivery destination information indicative of a delivery destination of a commodity into the recording medium when the recording medium is to be sold or in a like case. Under this condition, when commodity order acceptance information generated in an online store from which a commodity is to be purchased or lent through a communication system is to be processed and the commodity is to be purchased or rented, the reading apparatus reads the delivery destination information from the recording medium. The information processing apparatus for commodity order acceptance connected to the reading apparatus accepts an order or selection of the commodity and produces commodity order acceptance information. The information processing apparatus notifies an information processing apparatus for commodity order acceptance and delivery of the commodity order acceptance information by which the delivery destination information read by the reading apparatus and commodity selection information obtained by the acceptance of the order or selection of the commodity are associated with each other.

In the information processing system, the recording medium according to the present invention is applied and has recorded therein delivery destination information which represents a delivery destination of a commodity. When the commodity is to be purchased or rented, the delivery destination information is read from the recording medium.

With the information processing system, when a commodity is purchased or rented from an online store, an operation by a commodity purchasing person or the like of inputting an address of its home can be omitted. Consequently, the necessary operation can be reduced to an operation of passing or holding the recording medium through or over the reading apparatus. Besides, a commodity delivery center can deliver the commodity to the delivery destination based on the delivery destination information added to the commodity order acceptance information. Consequently, an electronic card utilization system, an electronic money card gift-giving system and so forth in which the delivery destination of a commodity is limited can be constructed.

According to a further embodiment of the present invention, there is provided an information processing method for processing commodity order acceptance information generated in an online store from which a commodity is to be purchased or lent through a communication system. The method includes a step of recording delivery destination information indicative of a delivery destination of the commodity into a recording medium for a charging process for settling a charge imposed on purchase or lending of the commodity. The method further includes steps, executed upon purchase or lending of the commodity, of reading the delivery destination information from the recording medium, accepting an order or selection of the commodity and acquiring commodity selection information, associating the delivery destination information read from the recording medium and the acquired commodity selection information with each other, and notifying an information processing system for commodity order acceptance and delivery of commodity order acceptance information by which the delivery destination information and the commodity selection information are associated with each other.

In the information processing method, the recording medium according to the present invention is applied and has recorded therein delivery destination information which represents a delivery destination of a commodity. When the commodity is to be purchased or rented, the delivery destination information is read from the recording medium.

In the information processing method, when commodity order acceptance information generated in an online store from which a commodity is to be purchased or lent through a communication system and the commodity is to be purchased or rented, the delivery destination information is read from the recording medium. Therefore, an operation by a commodity purchasing person or the like of inputting an address of its home can be omitted. Consequently, the necessary operation can be reduced to an operation of passing or holding the recording medium through or over a reading apparatus or the like.

Further, the commodity order acceptance information by which the delivery destination information read from the recording medium and the acquired commodity selection information are associated with each other is transferred. Therefore, a commodity delivery center can deliver the commodity to the delivery destination based on the delivery destination information added to the commodity order acceptance information. Consequently, an electronic card utilization system, an electronic money card gift-giving system and so forth in which the delivery destination of a commodity is limited can be constructed.

The above and other features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram showing an example of a configuration of an electronic money card utilization system according to an embodiment of the present invention;

FIG. 2 is a block diagram showing an example of a configuration of a terminal apparatus used in the electronic money card utilization system and can be connected to the Internet;

FIGS. 3A and 3B are a schematic view and a block diagram, respectively, showing an example of a configuration of a contactless electronic money card used in the electronic money card utilization system;

FIG. 4 is a view illustrating an example of storage of information in a memory section shown in FIG. 3B;

FIGS. 5 and 6 are flow charts illustrating an example of an information processing procedure in an electronic money card utilization system according to a first example of the present invention;

FIG. 7 is a block diagram showing an example of a configuration of an electronic money card gift-giving system according to a second example of the present invention;

FIG. 8 is a view illustrating an example of storage of information in a memory section of an electronic money card for use with the electronic money card gift-giving system of FIG. 7;

FIG. 9 is a flow chart illustrating an example of an initial registration/registration alteration procedure of delivery destination information in a card recording system of the electronic money card gift-giving system of FIG. 7;

FIG. 10 is a flow chart illustrating an example of an information processing procedure by a terminal apparatus used in the electronic money card gift-giving system of FIG. 7;

FIG. 11 is a block diagram showing an example of a configuration of an electronic money card utilization system according to a third example of the present invention; and

FIGS. 12A and 12B are a schematic view and a block diagram, respectively, showing a contactless electronic money card according to a fourth example of the present invention.

### DETAILED DESCRIPTION OF THE PREFERRED EMBODIMENT

Hereinafter, a recording medium, an information processing system and an information processing method according to a preferred embodiment of the present invention will be described with reference to the drawings.

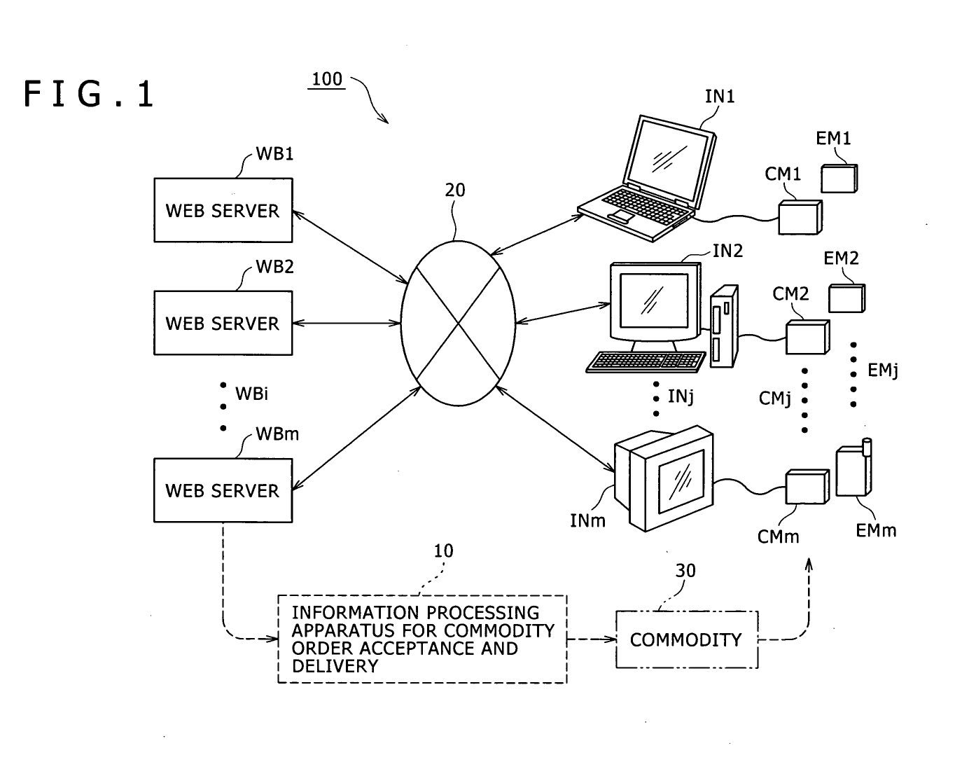

FIG. 1 shows an example of a configuration of an electronic money card utilization system 100 according to a preferred embodiment of the present invention.

Referring to FIG. 1, the electronic money card utilization system 100 shown is a form of an information processing system and generally processes commodity order acceptance information which is generated in an online store from which a commodity 30 is purchased or lent through the Internet 20 which is a form of a communication system. The commodity order acceptance information here is information for order acceptance of a commodity 30 to be soled from the online store. The commodity order acceptance information includes commodity selection information and delivery destination information. The commodity selection information is information representative of selection of a commodity 30 displayed by the online store. The delivery destination information is personal information such as the address, name and so forth of the delivery destination of a commodity 30 purchased or lent from the online store.

In the electronic money card utilization system 100, the commodity purchasing or renting person side is provided with a plurality of electronic money cards EMj (j=1 to m) each of which is an example of a recording medium for a charging process and settles the charge imposed on purchasing or lending of a commodity 30. In the electronic money card utilization system 100, delivery destination information is registered or recorded in each of the electronic money cards EMj. Such delivery destination information is registered or recorded into an electronic money card EMj when or after the electronic money card EMj is purchased. An automatic card selling machine may be set up so that such electronic money cards EMj may be sold from the automatic card selling machine. When a user itself uses its electronic money card EMj, it records the address and name, that is, delivery destination information, of the user itself into the card.

For such sales, for example, the automatic card selling machine is provided with a recording apparatus such that, regarding a person who tries to purchase an electronic card, delivery destination information which is address information representative of the delivery destination of a commodity 30 is recorded into the electronic money card EMj of the purchasing person. It is to be noted that, the configuration is not limited to this. The delivery destination information can be recorded into the electronic money card EMj when the person uses an online store for the first time to purchase the commodity 30.

In the electronic money card utilization system 100, a portable telephone set EMm having an equivalent function to that of the electronic money card EMj may be used in addition to the electronic money cards EMj as a recording medium for a charging process. A memory is provided in the portable telephone set EMm, and the delivery destination information is recorded into the memory. When an order for a commodity 30 sold from an online store is to be accepted, information can be communicated using an infrared communication apparatus, a short-distance radio communication function or the like.

In the electronic money card utilization system 100, the delivery destination information registered in the electronic money card EMj is read out by any of card communication apparatus CMj (j=1 to m) which have a function of a reading apparatus. The card communication apparatus CMj preferably have an information writing function in addition to the information reading out function. This is because, when a commodity 30 is purchased first from an online store, the delivery destination information can be recorded into the electronic money card. Preferably, a card communication apparatus CMj is provided for each Internet connection terminal.

For the card communication apparatus CMj, an information writing and reading out apparatus of the radio communication type or a radio transmission and reception apparatus of the infrared type is used. Thus, the card communication apparatus CMj has a repeating function with a terminal apparatus INj, the electronic money card EM1, the portable telephone set EMm or the like and can perform a communication process with the terminal apparatus INj, electronic money card EM1, portable telephone set EMm or the like.

To the card communication apparatus CMj, the Internet-connectable terminal apparatus INj (j=1 to m) which construct a function of an information processing apparatus for acceptance of a commodity order are connected individually. Thus, each of the card communication apparatus CMj accepts an order or selection of a commodity 30 and acquires commodity selection information D12. Each of the terminal apparatus INj has a function of establishing connection to the Internet 20 and a function of displaying commodity information, settlement information and so forth of an online store or outputting commodity selection information D12.

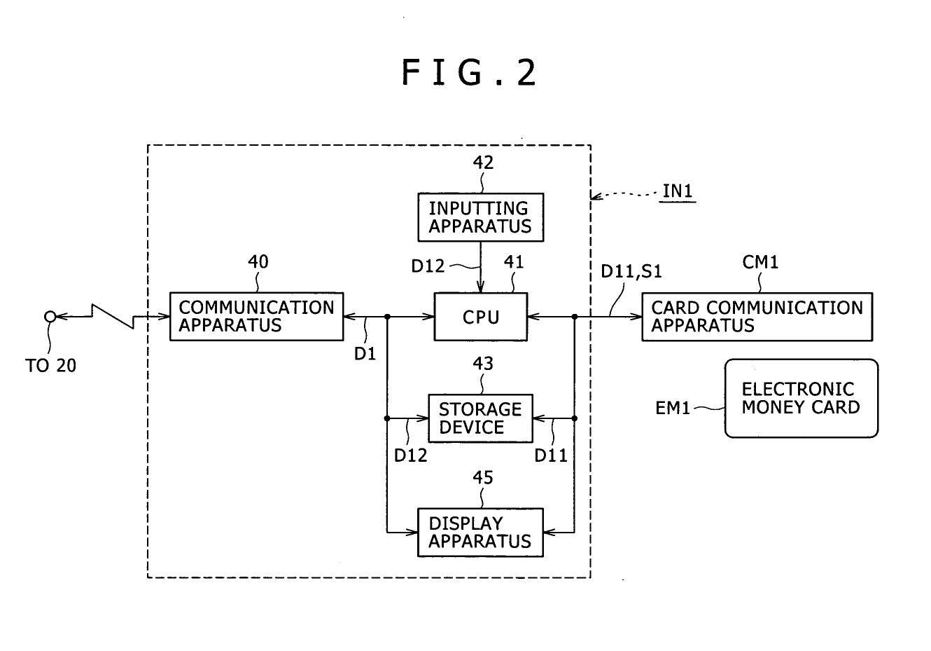

For the terminal apparatus INj, a personal computer of the notebook type, a personal computer of the desk top type, a television receiver having a communication function or a like apparatus is used. The terminal apparatus INj issues a notification of commodity order acceptance information D1, which associates delivery destination information read by the card communication apparatus CMj and commodity selection information D12 obtained from an inputting apparatus 42 (hereinafter shown in FIG. 2) with each other, to an information processing system for commodity delivery or management.

On the other hand, on the commodity selling or lending party side, web servers WBi (i=1 to n) which construct an information delivery system are provided. Each of the web servers WBi provides display information for displaying an image of a commodity, explanation of the commodity, the price of the commodity, a method of payment for the commodity and so forth and distributes information necessary for sales or lending of a commodity from an online store.

Meanwhile, each web server WBi performs a shipment process for a commodity 30 if a charging process performed later results in success based on delivery designation information received from the terminal apparatus INj upon such delivery of the information. If the charging process results in NG, then the web server WBi issues a notification for urging to select another commodity. For example, the web server WB1 transfers commodity order acceptance information D1 received from the terminal apparatus INj to the information processing system for commodity delivery and management.

The web servers WBi on the commodity setting or lending party side and the Internet-connectable terminal apparatus INj on the commodity purchasing or renting party side are connected to each other by the Internet 20 which is a form of a communication system. The communication system includes, in addition to the Internet 20, a public telephone network and a dedicated communication network.

On the commodity seller side described above, an information processing apparatus 10 for commodity order acceptance and delivery is provided. The information processing apparatus 10 manages acceptance of an order and delivery of a commodity 30 based on commodity order acceptance information D1 transferred thereto from the web server WBi. For example, a personal computer is used as the information processing apparatus 10 and manages delivery of a commodity 30 whose order is accepted. The information processing apparatus 10 is disposed in a commodity delivery center and distributes a commodity 30 to the place of an address based on delivery destination information. Consequently, the electronic money card utilization system 100 wherein the delivery destination of a commodity 30 is limited can be configured.

FIG. 2 shows an example of a configuration of the terminal apparatus IN1 which can be connected to the Internet. Referring to FIG. 2, the terminal apparatus IN1 includes a communication apparatus 40, a CPU 41, an inputting apparatus 42, a storage device 43 and a display apparatus 45.

The communication apparatus 40 is connected at one end thereof to the Internet 20 and performs a communication process with a web server WBi with regard to sales or lending of a commodity from an online store. The communication apparatus 40 is formed from a communication modem and decodes and outputs content information relating to the online store encoded by and distributed from the web server WBi.

The CPU 41, storage device 43 and display apparatus 45 are connected to the other end of the communication apparatus 40. Content information relating to an online store provided from a web server WBi is stored into the storage device 43. The content information includes display information such as an image, explanation, the price, a method of payment and so forth of a plurality of commodities relating to sales or lending of the commodities from an online store. The storage device 43 is formed from a hard disk apparatus, a nonvolatile memory or the like.

The display apparatus 45 displays information necessary for sales or lending of a commodity from an online store based on content information in a decoded form. For example, the display apparatus 45 displays an image, explanation, the price, a method of payment and so forth of a plurality of commodities based on the content information provided from a web server WBi. The display apparatus 45 may be formed from a liquid crystal display apparatus, a PDP display apparatus, a CRT apparatus or the like.

A user would select a commodity or commodities to be purchased from among a plurality of commodities. For example, the inputting apparatus 42 is connected to the CPU 41 and operated so as to accept an order or selection of a commodity 30. The user would operate the inputting apparatus 42 to select a commodity or commodities displayed on the display apparatus 45. A keyboard and/or a mouse are used as the inputting apparatus 42. Commodity selection information D12 relating to the commodity or commodities selected by an operation of the inputting apparatus 42 is outputted to the CPU 41.

The card communication apparatus CM1 which has a function of a reading apparatus is connected to the CPU 41 such that it reads out delivery destination information D11 from the electronic money card EM1 under the reading control of the CPU 41. The delivery destination information D11 read out from the electronic money card EM1 is temporarily stored into the storage device 43. The delivery destination information D11 read out from the storage device 43 is displayed on the display apparatus 45 under the display control of the CPU 41.

The CPU 41 receives commodity selection information D12 from the inputting apparatus 42 and confirms an order or selection of a commodity or commodities 30 to produce commodity order acceptance information D1. For example, the CPU 41 merges delivery destination information D11 read by the card communication apparatus CM1 and commodity selection information D12 relating to commodities to be purchased selected on the screen image of the display apparatus 45 in an associated relationship with each other to produce commodity order acceptance information D1 (=D11+D12). Then, the CPU 41 issues a notification of the commodity order acceptance information D1 to the web server WBi through the communication apparatus 40.

Consequently, the terminal apparatus IN1 can be configured which is connected at one end thereof to the Internet 20 and at the other end thereof to the card communication apparatus CM1 and can communicate with the web server WBi or the like regarding sales or lending of a commodity from an online store and read out delivery destination information D11 from the electronic money card EM1.

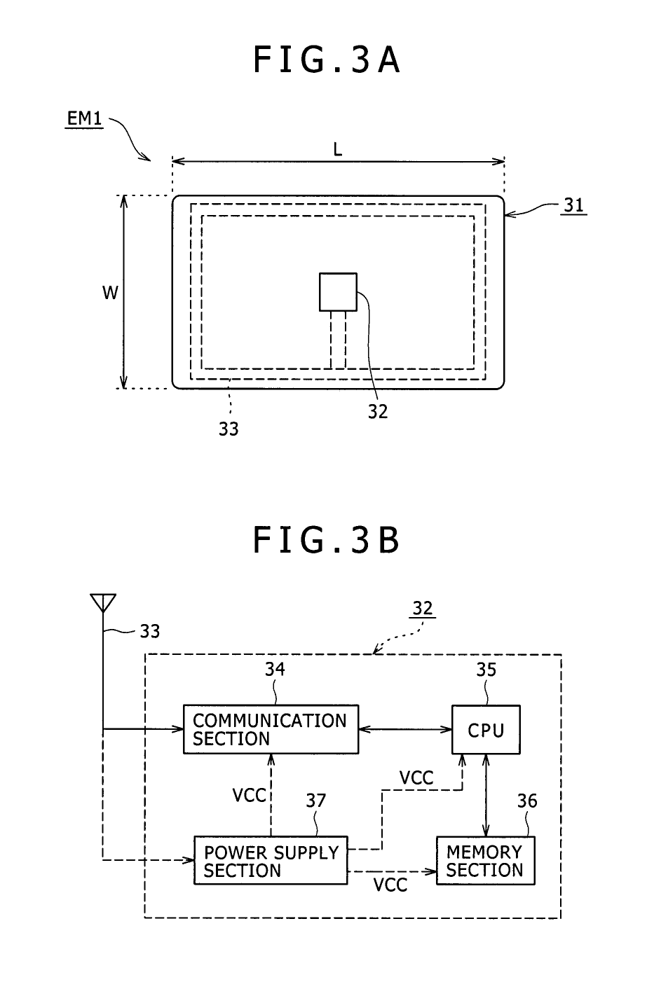

FIGS. 3A and 3B show an example of a configuration of the contactless electronic money card EM1 and so forth. In the arrangement shown in FIGS. 3A and 3B, an electronic recording card medium of the contactless type is used for the electronic money card EM1. The electronic recording card medium includes a prepaid/postpaid card (tag) or an Edy card of the contactless type by which a charging process can be performed.

The electronic money card EM1 for a charging process shown in FIG. 3A has a function of a recording medium for settling a charge imposed on purchase or lending of a commodity 30. The delivery destination information D11 which is address information representative of the delivery destination of the commodity 30 is recorded in the electronic money card EM1. The delivery destination information D11 is read out from the electronic money card EMj when the commodity 30 is purchased or lent.

The electronic money card EM1 shown in FIG. 3A has a card body portion 31 whose length L is approximately 80 to 90 mm and whose width W is approximately 50 to 60 mm and has a layered structure wherein an IC chip 32 and an antenna 33 are held by the card body portion 31. Since the electronic money card EM1 is of the contactless type, it has no terminals for information inputting/outputting thereon.

The antenna 33 mounted in the card body portion 31 includes a looped coil. The antenna 33 has a coil pattern of, for example, three turns. The IC chip 32 and a capacitor not shown are connected to the antenna 33, and the IC chip 32 has a remote IC function. The capacitor is used to harmonize the antenna 33 with a carrier frequency of an electromagnetic field to extract the reception efficiency to the utmost.

Naturally, where a drop of the reception efficiency is permitted, the capacitor may be omitted. The carrier frequency is approximately 13.56 MHz. Consequently, an electromagnetic field having a particular modulation radio wave into which the delivery destination information D11 or the like is converted can be received by the antenna 33 substantially of the card size L×W of the electronic money card EM1.

FIG. 3B shows an example of an internal configuration of the IC chip 32 of the electronic money card EM1 and so forth.

Referring to FIG. 3B, the IC chip 32 shown includes a communication section 34, a CPU 35, a memory section 36 and a power supply section 37.

The antenna 33 shown in FIG. 3A is connected to the communication section 34 and the power supply section 37. The communication section 34 connected to the antenna 33 performs a communication process with the card communication apparatus CM1 under the communication control of the CPU 35. For example, upon writing of information, the communication section 34 receives delivery destination information D11 modulated into a predetermined modulation radio wave. Upon reading out of information, the delivery destination information D11 is modulated into a predetermined modulation signal and signaled as such to the antenna 33.

The CPU 35 is connected to the communication section 34 and controls, upon writing and reading out of information, inputting and outputting of the communication section 34, memory section 36 and so forth. For example, upon reading of information, delivery destination information D11 readout from the memory section 36 is output to the communication section 34. On the contrary, upon writing of information, delivery destination information D11 obtained from the communication section 34 is recorded into the memory section 36.

The memory section 36 is connected to the CPU 35 described hereinabove such that delivery destination information D11 decoded by the communication section 34 or charging information is stored into the memory section 36 and control data in an information writing or reading out procedure is stored into the memory section 36. The memory section 36 is formed from a nonvolatile memory such as a read-only memory (EEPROM) which allows electric erasure and writing of information. Since a nonvolatile memory is used, even if the power supply is disconnected, delivery destination information D11, charging information and so forth are recorded and retained therein.

The power supply section 37 connected to the antenna 33 is further connected to the communication section 34, CPU 35 and memory section 36 such that it supplies a dc voltage VCC to the communication section 34, CPU 35 and memory section 36. For example, the power supply section 37 uses a method used in an ordinary IC card of the contactless type to fetch electromagnetic energy from the outside through the antenna 33 and supplies a dc voltage VCC produced based on the thus fetched electromagnetic energy to the communication section 34, CPU 35 and memory section 36.

In the arrangement shown in FIGS. 3A and 3B, electromagnetic force generated by electromagnetic induction from the card communication apparatus CM1 side is rectified to obtain the dc voltage VCC. According to an example of a carrier frequency of approximately 13.56 MHz by three turns, a DC power supply of a voltage of 2.2 V and current of approximately 1 mA is obtained. Naturally, a different method of fetching power by high frequency electromagnetic energy from the outside into the antenna 33 or some other substance to produce power may be used.

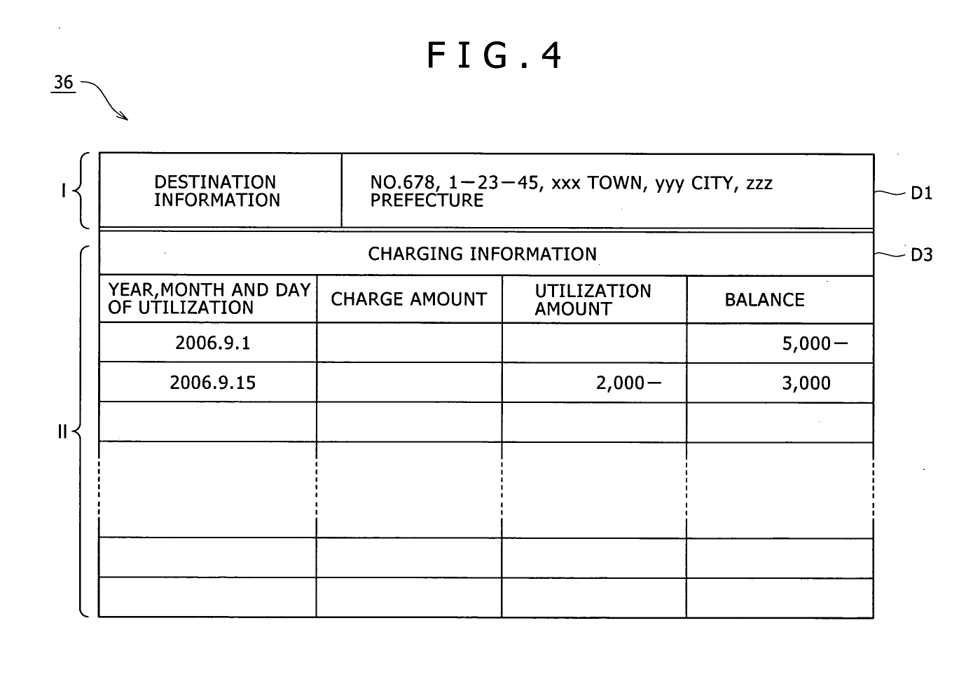

FIG. 4 illustrates an example of storage of information in the memory section 36 shown in FIG. 3B. In the memory section 36 shown in FIG. 4, delivery destination information D11 is stored in addition to charging information.

The memory section 36 has a memory area of a predetermined capacity, to which a delivery destination information recording area I and a charging information describing area II are allocated.

In the delivery destination information recording area I, delivery destination information D11 of a person who purchases the electronic money card EM1 is stored.

For example, the delivery destination information D11 describes personal information such as an address representative of the delivery destination of a commodity such as “No. 678, 1-23-45, xxx Town, yyy City, zzz Prefecture”. Naturally, the delivery destination information D11 may additionally include postal code information. The delivery destination information D11 and the postal code information are recorded using the recording apparatus of the automatic card selling machine, for example, upon purchasing of the electronic money card EM1.

The charging information describing area II describes the year, month and day of utilization, charge amount, utilization amount and balance as charging information. For example, if the electronic money card EM1 of the price of 5,000 yen is purchased on Sep. 1, 2006, then “2006. 9. 1” is described in the year, month and day of utilization, and 5,000 yen is described in the balance. Thereafter, if a commodity of the price of 2,000 yen is purchased at an online store on September 15, then “2006. 9. 15” is described in the year, month and day of utilization, and 3,000 yen is described in the balance. Consequently, the delivery destination information D11 can be stored into the memory section in addition to the charging information.

Where the electronic money card EM1 is configured in this manner, when a commodity 30 is to be purchased or a rental commodity 30′ is to be rented from an online store, an operation by a commodity purchasing person or the like of inputting an address of its home can be omitted. Thus, the necessary operation can be reduced to an operation of passing or holding up the electronic money card EM1 through or over the card communication apparatus CM1 or the like. Besides, the commodity delivery center can deliver a commodity 30 to the delivery destination based on the delivery destination information D11 added to the commodity order acceptance information D1.

### FIRST EXAMPLE

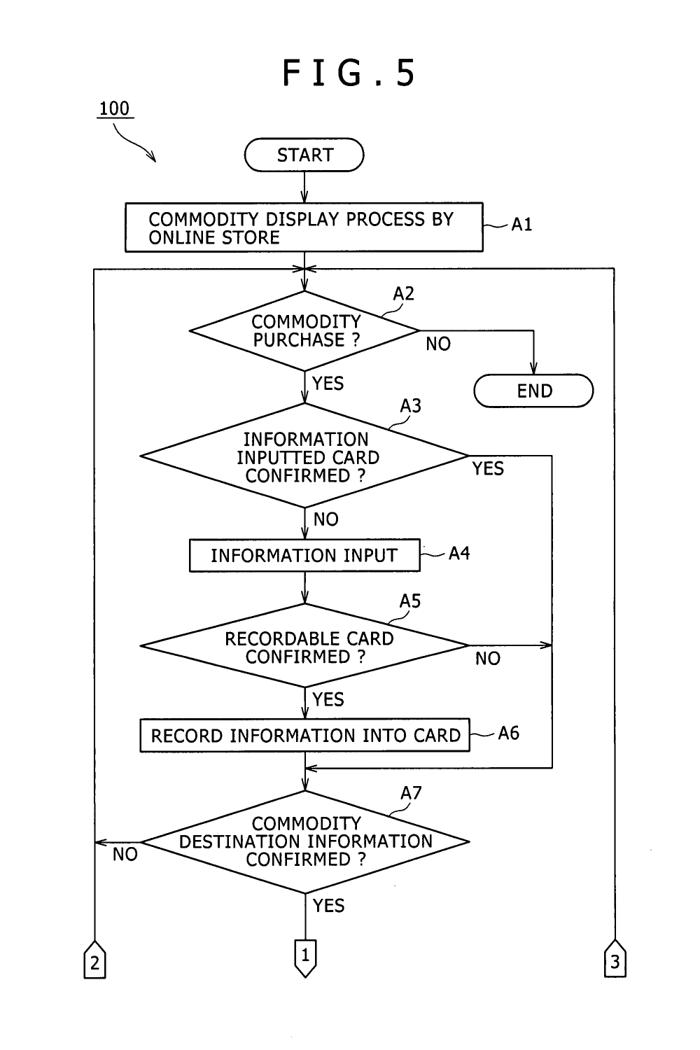

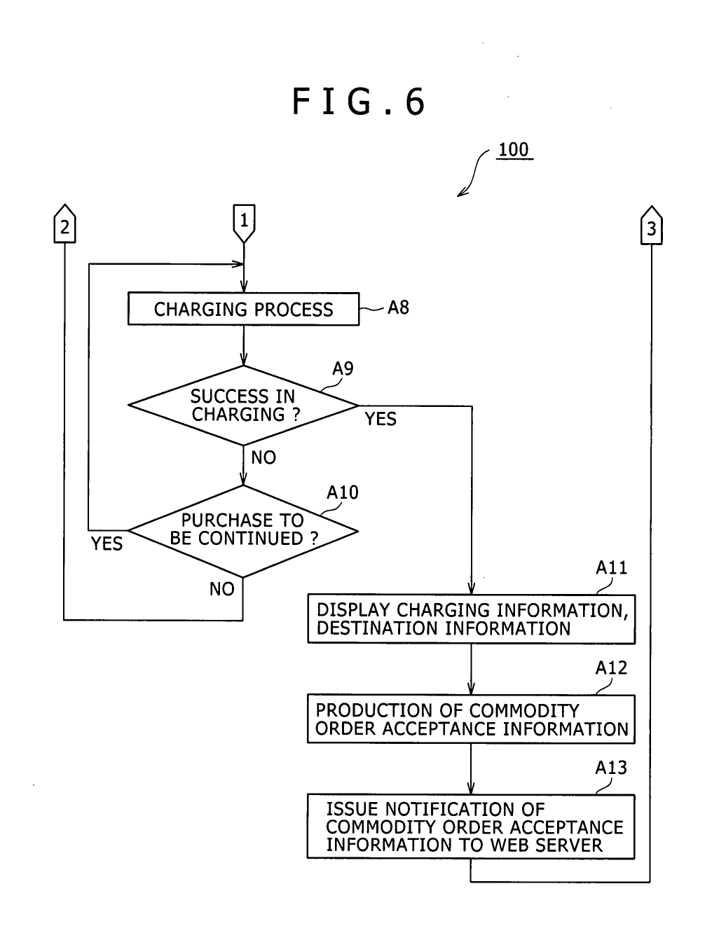

FIGS. 5 and 6 illustrate an example of an information processing procedure by the electronic money card utilization system 100 according to a first example.

In the present example, it is presupposed that the electronic money card EM1 for settling a charge imposed on purchasing of a commodity 30 or the portable telephone set EMm having an equivalent function is applied and commodity order acceptance information D1 which is generated in an online store from which the commodity 30 can be purchased through the Internet 20 is processed.

In other words, in the example described below, a commodity 30 is sent to a user not through the Internet but by such means as mailing. Then, the user would use the terminal apparatus IN1 such as a personal computer or a TV receiver with a communication function to access the web server WB1 and select a commodity 30 to be purchased. The terminal apparatus IN1 communicates with the electronic money card EM1 for a charging process or the portable telephone set EMm through the card communication apparatus CM1 and reads out and transmits the delivery destination information D11 recorded in the electronic money card EM1 or portable telephone set EMm to the web server WB1 or the like.

It is to be noted that the electronic money card EM1 or the portable telephone set EMm may already have the delivery destination information D11 stored therein, or may not have the delivery destination information D11 recorded therein as yet. Alternatively, in the latter case, the delivery destination information D11 may be recorded into the electronic money card EM1 or the portable telephone set EMm when a commodity is purchased, or the electronic money card EM1 or the portable telephone set EMm of the type into which the delivery destination information D11 cannot be recorded may be handled.

Under such processing conditions as described above, the user would start the terminal apparatus IN1 to access the web server WB1 or the like relating to an online store. At step A1 of the flow chart shown in FIG. 5, the terminal apparatus IN1 displays commodities 30 from the online store on the display apparatus 45. At this time, the display apparatus 45 displays an image, explanation, the price, a method of payment and so forth of a plurality of commodities based on content information provided from the web server WBi.

Then at step A2, the terminal apparatus IN1 branches its control depending upon an operation of whether or not a commodity 30 is to be purchased from the user. If a commodity 30 is to be purchased, then the terminal apparatus IN1 accepts an order or selection of a commodity 30 on the screen image of the display apparatus 45. At this time, if the user operates the inputting apparatus 42 to select a commodity 30 to be purchased, then commodity selection information D12 is outputted from the inputting apparatus 42 to the CPU 41 in response to the selection operation.

Then at step A3, the terminal apparatus IN1 executes a confirmation process regarding whether the electronic money card EM1 or the portable telephone set EMm having an equivalent function in which the delivery destination information D11 is recorded is used. At this time, the display apparatus 45 displays such a message as “Please pass or hold an electronic money card or a portable telephone set through or over the card communication apparatus.” The user would pass or hold the electronic money card EM1 or the portable telephone set EMm through or over the card communication apparatus CM1 in response to the display.

For example, if the electronic money card EM1 or the portable telephone set EMm is held over the card communication apparatus CM1, then the card communication apparatus CM1 reads the delivery destination information D11 from the electronic money card EM1. In this instance, for example, from the delivery destination information recording area I shown in FIG. 4, such delivery destination information D11 as “No. 678, 1-23-45, xxx Town, yyy City, zzz Prefecture” is read out. Naturally, the delivery destination information D11 may additionally include postal number information. The delivery destination information D11 and/or the postal number information are recorded using the recording apparatus of the automatic card selling machine, for example, when the electronic money card EM1 is purchased.

If delivery destination information D11 is read from the electronic money card EM1 or portable telephone set EMm, then the card communication apparatus CM1 outputs a reading possibility signal S1 representing that it is possible to read the delivery destination information D11 to the terminal apparatus IN1. Consequently, the terminal apparatus IN1 can confirm based on the reading possibility signal S1 inputted thereto from the card communication apparatus CM1 that the electronic money card EM1 or portable telephone set EMm has the delivery destination information D11 already recorded therein. If the electronic money card EM1 or portable telephone set EMm in which the delivery destination information D11 is recorded already is confirmed, then the processing advances to step A7.

If the electronic money card EM1 or portable telephone set EMm has no delivery destination information D11 recorded therein or is of the type which does not allow recording of delivery destination information D11 therein, then the reading possibility signal S1 is not issued from the card communication apparatus CM1. In this instance, the processing advances to step A4, at which the terminal apparatus IN1 issues an urging notification to perform a writing process of delivery destination information D11 into the electronic money card EM1 or portable telephone set EMm.

For example, the terminal apparatus IN1 tries to record or input delivery destination information D11 into the electronic money card EM1 or portable telephone set EMm through the card communication apparatus CM1. Thereafter, the processing advances to step A5, at which the terminal apparatus IN1 confirms or decides whether the electronic money card EM1 or portable telephone set EMm is of the type which allows recording of delivery destination information D11 therein. At this time, the card communication apparatus CM1 reads delivery destination information D11 from the electronic money card EM1 or portable telephone set EMm.

If the electronic money card EM1 or portable telephone set EMm is of the type which allows recording of delivery destination information D11 therein, then the processing advances to step A6, at which the terminal apparatus IN1 records the delivery destination information D11 which is address information indicative of the delivery destination of the commodity 30 into the electronic money card EM1 or portable telephone set EMm. Then, the processing advances to step A7.

It is to be noted that, if it is decided at step A5 that the electronic money card EM1 or portable telephone set EMm is of the type which does not allow recording of delivery destination information D11 therein, then the processing skips step A6 and advances directly to step A7. At step A7, the terminal apparatus IN1 decides whether or not the delivery destination information D11 of the commodity 30 is acquired successfully. This decision is made after it is confirmed by the user whether or not the data acquired or inputted may be used as the delivery destination information D11.

At this time, if it has been decided formerly that the electronic money card EM1 or portable telephone set EMm is of the type which does not allow recording of delivery destination information D11 therein, then the terminal apparatus IN1 urges the user to input delivery destination information D11 using the inputting apparatus 42. The permission of inputting here is intended to give accommodation to the electronic money card EM1 or portable telephone set EMm of the type which does not allow recording of delivery destination information D11 therein.

When the delivery destination information D11 of the commodity cannot be acquired successfully irrespective of such a process as described above or when a commodity 30 is to be purchased and inputting is attempted again, the processing returns to step A2 including a case wherein the delivery destination information D11 should not be used or the like. At step A2, if a commodity 30 is not to be purchased or the destination of delivery of a commodity 30 to be purchased cannot be inputted or registered, then the information process for the online store is ended. When inputting is to be attempted again, the processing advances to step A3 to repeat the processes described hereinabove.

If it is decided at step A7 that reading out of the delivery destination information D11 is performed successfully and the delivery destination information D11 of a commodity 30 by new setting or an inputting operation is acquired successfully, then the processing advances to step A8 illustrated in FIG. 6. Referring now to FIG. 6, at step A8, the terminal apparatus IN1 executes a charging or settlement process for the purchase of the commodity 30. The charging process is executed, for example, by rewriting charge information stored in the electronic money card EM1 or portable telephone set EMm. In the example described, the year, month and day of utilization, utilization amount and balance in the charging information describing area II shown in FIG. 4 are rewritten (refer to FIG. 4).

Thereafter, the terminal apparatus IN1 confirms at step A9 whether the charging process is completed successfully.

If the charging process is completed successfully, then the processing advances to step A11, at which the terminal apparatus IN1 displays the charge information and the delivery destination information D11 on the display apparatus 45 to notify the user. Then, the processing advances to step A12.

It is to be noted that, if the charging process is completed otherwise in failure, then the processing advances to step A10, at which the terminal apparatus IN1 confirms whether or not the charging process is to be attempted again. At this time, a message such as “Should the charging process be attempted again?” is displayed on the display apparatus 45. In addition to the message, icons of “continuation”, “suspension” and so forth are displayed on the display apparatus 45. At this time, if the icon of “continuation” is depressed by the user, that is, if the charging process is to be continued, then the processing returns to step A8. On the other hand, if the user depresses the icon of “suspension”, that is, if the charging process is to be suspended, then the processing returns to step A2.

After the charging information and the delivery destination information D11 are displayed on the display apparatus 45 at step A11, the processing advances to step A12. At step A12, the terminal apparatus IN1 merges the delivery destination information D11 acquired by the information reading out process, new information setting process, inputting operation or the like and the commodity selection information D12 outputted from the inputting apparatus 42 in an associated relationship with each other to produce commodity order acceptance information D1. Thereafter, the processing advances to step A13, at which the terminal apparatus IN1 issues a notification of the commodity order acceptance information D1 which associates the delivery destination information D11 and the commodity selection information D12 with each other to the web server WB1 or the like.

Consequently, a commodity 30 to be purchased which has been selected on the display apparatus 45 by the user through accessing to the web server WB1 or the like using the terminal apparatus IN1 can be delivered to the user, that is, to the delivery destination, based on the delivery destination information D11 added to the commodity order acceptance information D1 by the commodity delivery center.

In this manner, with the electronic money card utilization system 100 and the information processing method according to the first example, when a card is sold or when a commodity is purchased, delivery destination information D11 is recorded into an electronic money card EM1 or a portable telephone set EMm. Then, where commodity order acceptance information D1 generated in an online store from which a commodity 30 is to be purchased through the Internet 20 is to be processed, when the commodity 30 is purchased, the card communication apparatus CM1 reads the delivery destination information D11 from the electronic money card EM1. The terminal apparatus IN1 connected to the card communication apparatus CM1 accepts the order for the commodity 30 and produces commodity order acceptance information D1. The terminal apparatus IN1 produces commodity order acceptance information D1 which associates the delivery destination information D11 read by the card communication apparatus CM1 and the commodity selection information D12 with each other and issues a notification of the commodity order acceptance information D1 to the information processing apparatus 10 through the web server WBi.

Accordingly, when a commodity 30 is to be purchased from an online store, the commodity purchasing person or the like can omit the operation of inputting the address of its home and the name. Consequently, the operation of the commodity purchasing person or the like can be reduced to an operation of passing or holding the electronic money card EM1 through or over the card communication apparatus CM1 or the like. Besides, the commodity delivery center or the like can deliver the commodity 30 based on the delivery destination information D11 added to the commodity order acceptance information D1 to the delivery destination.

Further, since the electronic money card utilization system 100 can be implemented, the delivery destination information D11 is recorded in the electronic money card EM1 or the portable telephone set EMm itself having an equivalent function which is used actually for charging. Consequently, for each settlement card to be utilized, the delivery destination of a purchased commodity can be specified irrespective of the online store utilized by the user. In other words, the electronic money card EM1 or the portable telephone set EMm having an equivalent function into which delivery destination information D11 is inputted through the charging or settlement process by the web server WB1 shown in FIG. 1 is permitted also to use information inputted from another one of the web servers WB2 to WBn.

Furthermore, since movement of the electronic money card EM1 or the portable telephone set EMm itself is easy and no data is left in the terminal apparatus IN1 for the connection to the Internet, it is easy for the user to manage its personal information such as the name and the address included in the delivery destination information D11. The electronic money card EM1 or the portable telephone set EMm having an equivalent function into which the delivery destination information D11 is inputted through the charging or settlement process by the web server WB1 shown in FIG. 1 is permitted to use information inputted also from the different terminal apparatus IN2 or terminal apparatus IN1.

The electronic money card utilization system 100 described above can be applied not only to a network shopping system but also to a commodity home delivery. The electronic money card utilization system 100 can be applied also to a catalog sales system in which a commodity is selected from within a catalogue.

### SECOND EXAMPLE

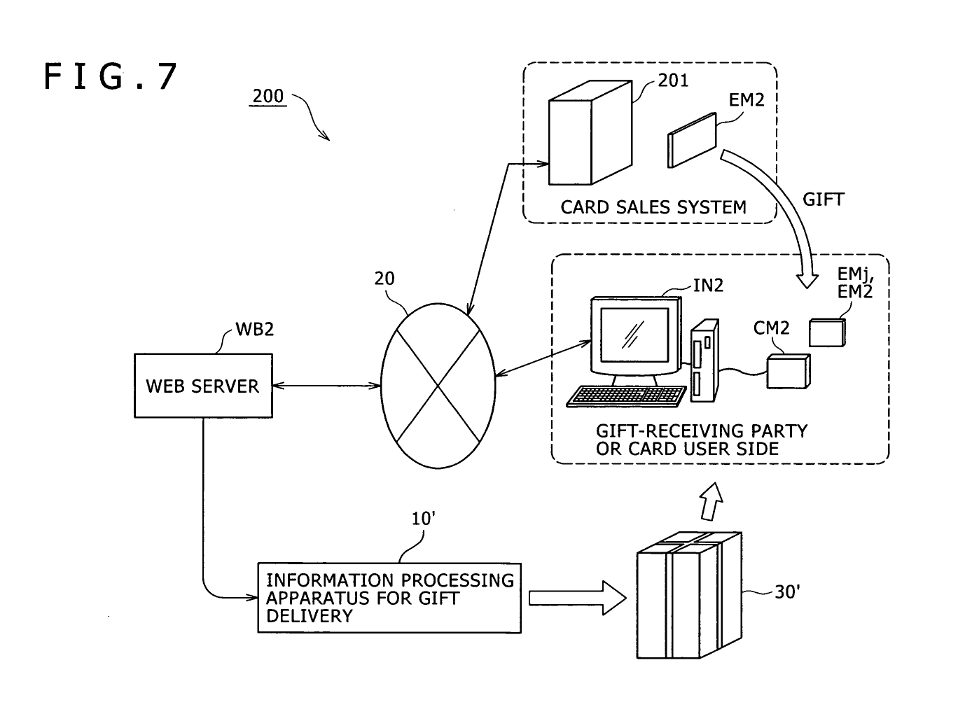

FIG. 7 shows an example of a configuration of an electronic money card gift-giving system 200 according to a second example of the present invention. Referring to FIG. 7, the electronic money card gift-giving system 200 shown is another example of the information processing system and processes gift delivery information D2 which is generated in an online store which receives an order of a gift 30′ through the Internet 20 and delivers the gift 30′. The electronic money card gift-giving system 200 is an application of the electronic money card utilization system 100 according to the first example and includes a card sales system in addition to the web server WB2, terminal apparatus IN2 and card communication apparatus CM2 of the electronic money card utilization system 100. The card sales system includes an automatic card selling machine 201.

In the electronic money card gift-giving system 200, delivery destination information D21, which represents the address of a gift-receiving party, of a gift 30′ which is to be given as a return gift regarding a happy event from a gift-giving party to the gift-receiving party is recorded or registered into an electronic money card EM2. Then, when the gift-receiving party acquires the gift 30′, it operates the card communication apparatus CM2 to notify the web server WB2 of gift delivery information D2 which merges delivery destination information D21 read out from the electronic money card EM2 and gift selection information D22 relating to the gift 30′ selected from a gift group by the gift-receiving party so as to allow the online store, which receives an order of and delivers the gift 30′, to deliver the gift 30′ based on the gift delivery information D2 to the address of the gift-receiving party.

In the present electronic money card gift-giving system 200, the electronic money card EM2 in which the balance is recorded is presented as a return gift regarding a wedding ceremony or the like from the gift-giving party side to the gift-receiving party side, and the balance is cleared in response to selective acquisition (utilization money amount) of the gift 30′. Thereafter, if the electronic money card EM2 is charged to increase the balance, then the electronic money card EM2 can be utilized also as in the electronic money card utilization system 100 of the first example.

In the electronic money card gift-giving system 200, the delivery destination information D21 of the gift-receiving party is registered or recorded into the electronic money card EM2. The delivery destination information D21 is registered or recorded into the electronic money card EM2 by the gift-giving party side utilizing a predetermined recording apparatus. For example, when the electronic money card EM2 is purchased from the automatic card selling machine 201, the address and name of the gift-giving party, that is, the delivery destination information D21, is recorded.

Also in the present electronic money card gift-giving system 200, similarly as the first example, the delivery destination information D21 is read from the electronic money card EM2 by an operation of passing or holding the electronic money card EM2 through or over the card communication apparatus CM2. The terminal apparatus IN2 which can be connected to the Internet is connected to the card communication apparatus CM2 similarly as in the electronic money card utilization system 100 of the first example and accepts of selection of a gift 30′ to produce gift selection information D22. The terminal apparatus IN2 has a function of establishing connection to the Internet 20, another function of displaying gift information, settlement completion information and so forth and a further function of outputting the gift selection information D22.

For the terminal apparatus IN2, a personal computer of the notebook type, a personal computer of the desk top type, a television receiver having a communication function or the like is used similarly as in the first example. The terminal apparatus IN2 issues a notification of gift delivery information D2, which associates the delivery destination information D21 read by the card communication apparatus CM2 and the gift selection information D22 with each other, to the information processing system for gift delivery and management.

The gift delivery party side includes the web server WB2 which composes an information distribution system such that it provides display information for displaying an image and explanation of the gift and distributes information necessary for delivery of the gift from the online store.

Further, the web server WB2 performs a shipment process for the gift 30′ if a settlement process which is performed later results in success based on the delivery destination information D21 received from the terminal apparatus IN2 in response to the distribution of the information. If the settlement process results in NG, then the web server WB2 issues an urging notification to select another gift. For example, the web server WB2 transfers the gift delivery information D2 received from the terminal apparatus IN2 to the information processing system for gift delivery and management.

The web server WB2 of the gift delivery party side and the terminal apparatus IN2 on the gift-receiving party side which can be connected to the Internet are connected to each other by the Internet 20 or the like in a similar manner as in the electronic money card utilization system 100 of the first example. The gift delivery party side described above includes, for example, an information processing apparatus 10′ for gift order reception and delivery such that it manages order acceptance and delivery of a gift 30′ based on the gift delivery information D2 transferred thereto from the web server WB2. For the information processing apparatus 10′, for example, a personal computer is used and manages delivery of a gift 30′ whose order is accepted. The information processing apparatus 10′ is disposed in the gift delivery center and performs delivery of the gift 30′ to an address based on the delivery destination information D21. Consequently, the electronic money card gift-giving system 200 which handles a gift 30′ whose delivery destination is limited can be configured.

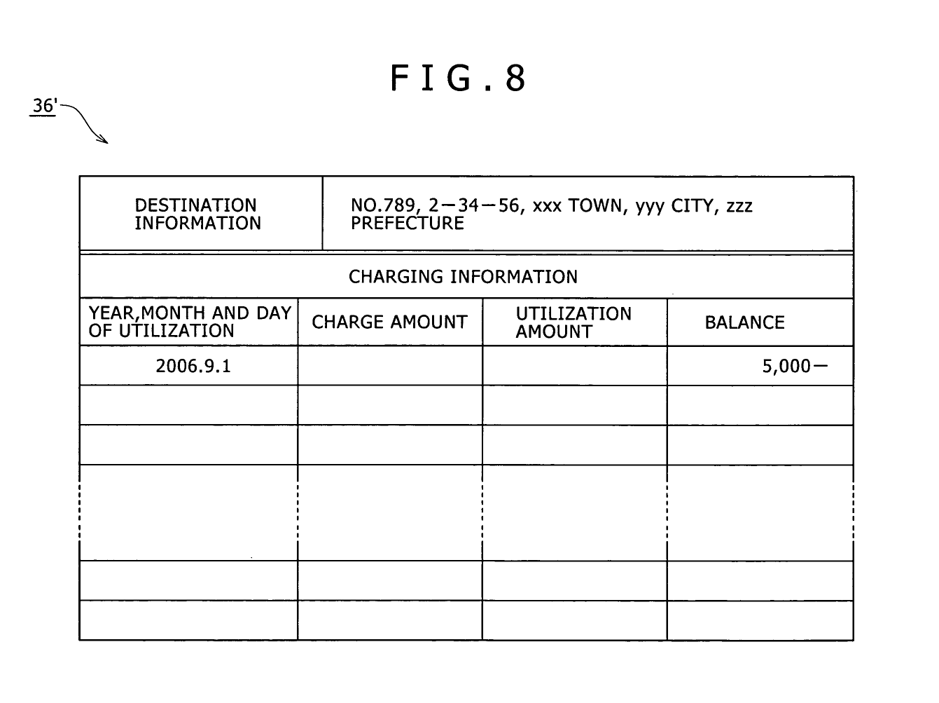

FIG. 8 illustrates an example of storage of information in a memory section 36′ of the electronic money card EM2. Into the memory section 36′ shown in FIG. 8, delivery destination information D21 of a gift-receiving party is stored in addition to charging information representative of the balance.

Also in the memory section 36′, a memory area of a predetermined capacity is provided similarly as in the first example. To the memory region, a delivery destination information recording area I and a charging information describing area II are allocated. In the delivery destination information recording area I, delivery destination information D21 of a gift-receiving party which is the opposite party to which an electronic money card EM2 is to be presented by the gift-giving party side is recorded or registered.

For example, the delivery destination information recording area I describes personal information such as the address and name of the gift-giving party representative of the delivery destination of a gift 30′ such as “No. 789, 2-34-56, xx Town, yy City, zz Prefecture”. Naturally, postal number information may be added to the delivery destination information D21. The delivery destination information D21 and the postal number information are recorded using the recording apparatus of the automatic card selling machine 201 when the electronic money card EM2 is purchased. In the charging information describing area II, places for description of the year, month and day of utilization, charge amount, utilization amount, balance and so forth as charge information are provided. In the example illustrated in FIG. 8, 5,000 yen is described in the place for description of the balance.

Where the electronic money card EM2 is configured in this manner, when the a gift 30′ is to be selectively acquired from an online store which receives an order of and delivers gifts 30′, an operation by the gift-receiving party of inputting the address of its home can be omitted. Thus, the necessary operation can be reduced to an operation of passing or holding the electronic money card EM2 through or over the card communication apparatus CM2. Besides, the gift delivery center can deliver a gift 30′ to the address of the gift-receiving party, that is, to the delivery destination, based on the delivery destination information D21 added to the gift delivery information D2.

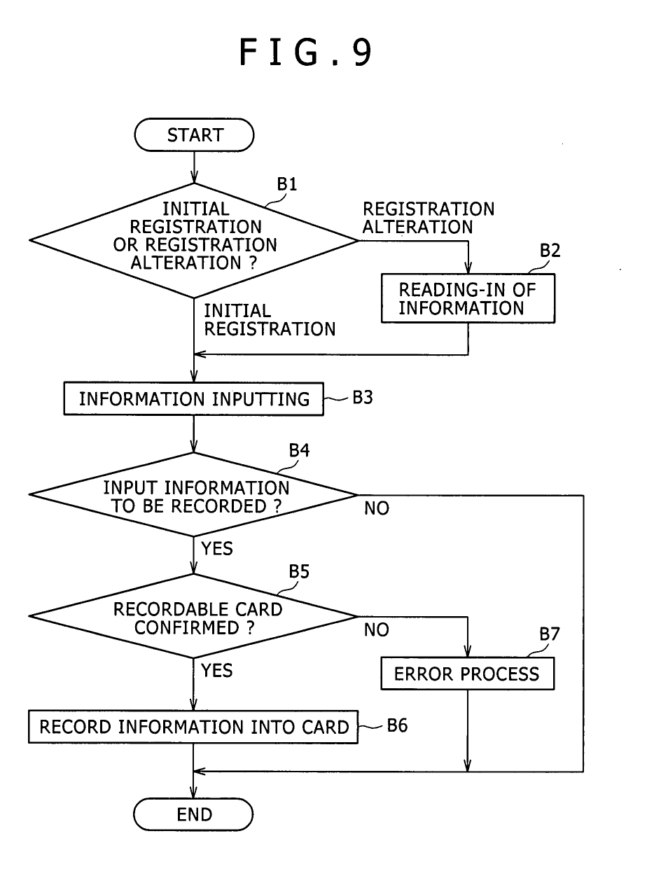

FIG. 9 illustrates an example of an initial registration or registration alteration process of the delivery destination information D21 (D11) by the card recording system.

In the present electronic money card gift-giving system 200, the automatic card selling machine 201, the card communication apparatus CM2 connected to the terminal apparatus IN2 in the user's home and so forth correspond to the card recording system. Further, in the electronic money card gift-giving system 200, a gift-giving party who purchases an electronic money card EM2 records the address and name of a gift-receiving party, that is, delivery destination information D21. This corresponds to a case wherein, in the electronic money card utilization system 100, a purchasing person who formerly purchased an electronic money card EM1 tries to change the registration of the address of its home because of a removal or the like. In this example, the card recording system of the automatic card selling machine 201 or the terminal apparatus IN2 to which the card communication apparatus CM2 is connected initially registers, or alters the registration of, the delivery destination information D21.

Under such processing conditions as described above, the card recording system branches its control depending upon which one of initial registration or alteration of a registration of the electronic money card EM1 should be performed at step B1 of the flow chart of FIG. 9. For example, the card processing system executes a conformation process of confirming whether it is requested to perform alteration registration of the electronic money card EM2 in which delivery destination information D21 is recorded already or to perform initial registration of the electronic money card EM2 in which delivery destination information D21 is not recorded as yet. In this instance, the case wherein the card recording system is the automatic card selling machine 201 and the stored information of the memory section 36′ is such as illustrated in FIG. 8 corresponds to initial registration of recording the address and name of the gift-receiving party, that is, the delivery destination information D21. On the other hand, the case wherein the card recording system is the terminal apparatus IN2 to which the card communication apparatus CM2 shown in FIG. 7 is connected corresponds to registration alteration or rewriting the delivery destination information D21 of the card user.

If it is decided at step B1 that registration alternation is to be performed, then the processing advances to step B2, at which the card recording system confirms whether or not the card communication apparatus CM2 can communicate with the electronic money card EM1 in which information is inputted already and the delivery destination information D21 is recorded. At this time, the display apparatus 45 displays such a message as “Please pass or hold the electronic money card through or over the card communication apparatus.” The user would pass or hold up the electronic money card EMj into or over the card communication apparatus CM2 in response to the display.

For example, if the electronic money card EM2 is held over, then the card communication apparatus CM2 reads the delivery destination information D21 from the electronic money card EM2. In the present example, the delivery destination information D21 such as “No. 678, 1-23-45, xxx Town, yyy City, zzz Prefecture” is read from the delivery destination information recording area I illustrated in FIG. 4.

If it is confirmed at step B1 by the card recording system to perform initial registration of the electronic money card EM2, then the processing advances to step B3. At step B3, the card recording system executes an information inputting process corresponding to initial registration of the electronic money card EM2 or registration alteration of the electronic money card EMj. At this time, if the initial inputting process is initial registration of the electronic money card EM2 to be executed in the electronic money card gift-giving system 200, the user would use an inputting tool of the automatic card selling machine 201 to input personal information of the address, name and so forth of a gift-receiving party indicative of the delivery destination of a gift 30′ such as, for example, “No. 789, 2-34-56, xx Town, yy City, zz Prefecture”.

On the other hand, if the information inputting process is registration alteration of the electronic money card EMj in the electronic money card utilization system 100, then the user would use the inputting apparatus 42 of the terminal apparatus to input personal information of the address, name and so forth of the card user indicative of the delivery destination of the commodity 30 such as, for example, “No. 700, 3-33-56, xxx Town, yyy City, zzz Prefecture” after a change of address.

Thereafter, the processing advances to step B4, at which the card recording system confirms whether or not the input information such as the personal information inputted for initial registration or registration alteration of the delivery destination information D21 is to be recorded into the electronic money card EM2 or EMj. The confirmation of recording is performed by the user operating an icon or the like not shown to issue an instruction to the card recording system.

When the input information is to be recorded into the electronic money card EM2, EMj or the like, the processing advances to step B5. At step B5, the card recording system executes confirmation of whether or not the electronic money card EM2, EMj or the like is a recordable card from confirmation of whether or not it can communicate. In other words, the card recording system tries to confirm whether or not it can communicate with the electronic money card EM2, EMj or the like to record information. If it is confirmed that information can be recorded, then the processing advances to step B6, at which the delivery destination information D21 is recorded.

In the example described above, if registration alteration to the electronic money card EMj is to be performed, then the description in the delivery destination information recording area I of the memory section 36 shown in FIG. 4, that is, “No. 678, 1-23-45, xxx Town, yyy City, zzz Prefecture”, is rewritten into “No. 700, 3-33-56, ccc Town, yyy City, zzz Prefecture” based on the input information inputted using the inputting apparatus 42 of the terminal apparatus INj.

On the other hand, if initial registration into the electronic money card EM2 is to be performed, then the personal information of the gift-receiving party such as “No. 789, 2-34-56, xx Town, yy City, zz Prefecture” inputted using the inputting tool of the automatic card selling machine 201 is described into the delivery destination information recording area I of the memory section 36′. If the input information is not to be recorded into the electronic money card EM2, EMj or the like at step B4 described hereinabove, then the information processing procedure is ended without performing initial registration or registration alteration of the delivery destination information D21. The card recording process is ended therewith.

It is to be noted that, if it is confirmed at step B5 by the card recording system that, although the electronic money card EM2, EMj or the like is a recordable card, it cannot communicate, then the processing advances to step B7, at which an error process is executed. For example, such an error message as “The delivery destination information cannot be described” is displayed on the display apparatus 45 or the like. The card recording process is ended abnormally therewith.

In the present example, where the card recording system corresponds to the automatic card selling machine 201, the operation at step B5 may be omitted. This is because it is apparent from the beginning that the electronic money card EM2 is a newly recordable electronic money card.

By performing such a recording process as described above, a gift-giving party can register delivery destination information D21 of the opposite party into the electronic money card EM2, and the electronic money card gift-giving system 200 can be configured such that a gift-giving party can perform an inputting process of delivery destination information D21 on behalf of a gift-receiving party. Further, since personal information of an owner is recorded into the electronic money card EMj, identification of the person can be performed readily. As a result, it is easy to decide whether or not the owner is a true proprietor whose delivery destination information D21 is registered in the electronic money card EMj or a mere holder of the card who may have found and holds the card by chance.

On the other hand, where information is to be recorded into the card at step B6, if information cannot be written into the electronic money card EM2 without authentication depending upon a key or has a function that the recorded substance therein cannot be changed without authentication depending upon a key, it is possible to disable later alteration registration of the delivery destination information D21 recorded once in the electronic money card EM2. From this, in the electronic money card gift-giving system 200, even if a third party illegally uses or abuses the card, the gift 30′ is not delivered to the home of the third party, but is delivered to a gift-receiving party (opposite party) of the gift delivery destination. Consequently, the safety is raised.

Further, even if an illegal user comes to know a unique number registered in the electronic money card EM2 from some cause and uses the electronic money card EM2 with the number, when the terminal apparatus IN2 which can be connected to the Internet is used, the number is tied with delivery destination information D21 of the illegal user by the web server WB2 or the like. Consequently, evidence becomes likely to remain, and therefore, there is an effect that illegal use of the card can be prevented.

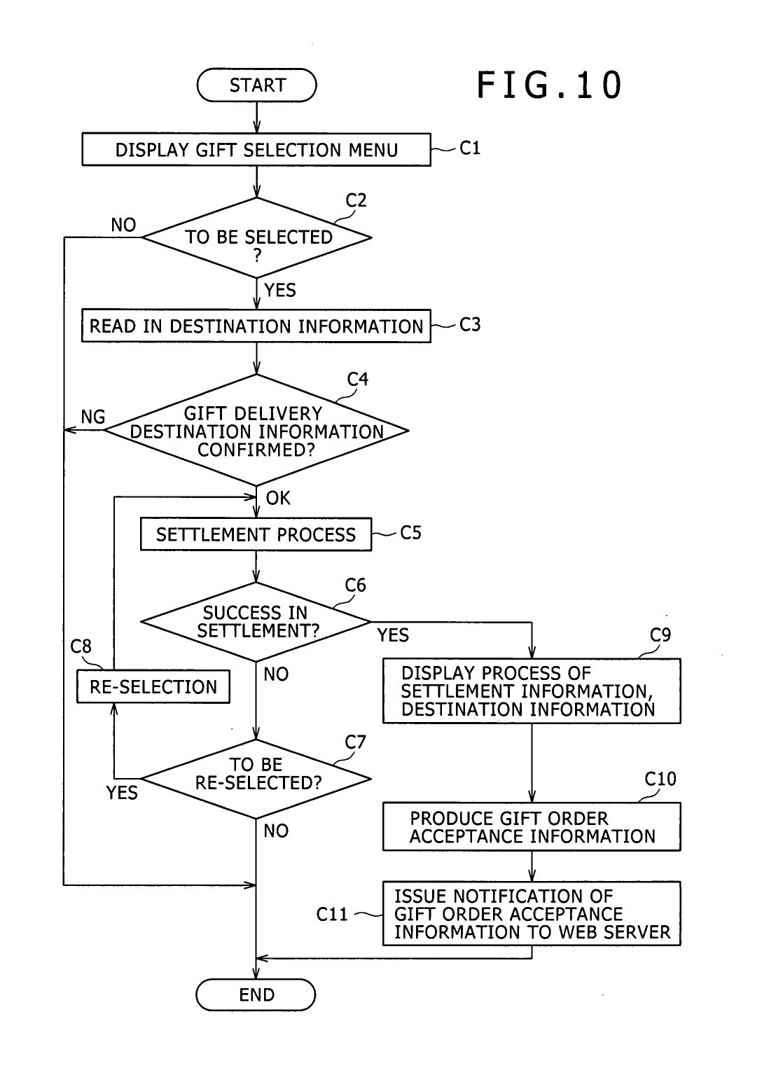

FIG. 10 illustrates an example of an information processing procedure of the terminal apparatus IN2 according to the second example.

In the present information processing procedure, it is presupposed that a gift-giving party passes an electronic money card EM2 to a gift-receiving party in the electronic money card gift-giving system 200. When the gift-giving party gives the electronic money card EM2 to the gift-receiving party, the electronic money card EM2 is passed with address information and so forth of the gift-receiving party recorded therein. Then it delivered to the address of the gift-receiving party. The electronic money card gift-giving system 200 eliminates the necessity for the gift-receiving party, to whom the electronic money card EM2 is presented, to input the address of the gift-receiving party itself using a terminal. Thus, the electronic money card gift-giving system 200 eliminates such a situation that a gift 30′ is handed in a situation of a happy event such as a wedding ceremony.

In the present information processing procedure, delivery destination information D21 of a gift 30′ indicative of an address of a gift-receiving party is registered into the electronic money card EM2, and when the gift-receiving party acquires the gift 30′, the delivery destination information D21 is read from the electronic money card EM2 by the card communication apparatus CM2 of an online store, and the gift 30′ is delivered to the address of the gift-receiving party based on the delivery destination information D21 registered in the electronic money card EM2.

Under such information processing conditions, the user would start the terminal apparatus IN2 to access to the web server WB2 relating to an online store as a specialty store for gifts or the like. The terminal apparatus IN2 communicates with the web server WB2 and displays a gift selection menu of the online store on the display apparatus 45 at step C1 of the flow chart of FIG. 10. At this time, the display apparatus 45 displays an image, explanation and so forth of a plurality of gifts 30′ based on content information provided from the web server WB2. The user would operate the inputting apparatus 42 to select any of the gifts 30′ displayed on the display apparatus 45.

Then at step C2, the terminal apparatus IN2 branches its control in response to an operation by the user regarding whether or not a gift 30′ is to be selected. If a gift 30′ is to be selected, then the terminal apparatus IN2 accepts selection of a gift 30′ on the screen image of the display apparatus 45. At this time, if the user operates the inputting apparatus 42 to select a gift 30′ to be acquired, then gift selection information D22 is outputted from the inputting apparatus 42 to the CPU 41 in response to the operation.

If a gift 30′ to be made an object of delivery is generated by selection by the user, then the processing advances to step C3, at which the terminal apparatus IN2 reads out the delivery destination information D21 from the electronic money card EM2. For example, the card communication apparatus CM2 reads out personal information of the gift-receiving party such as “No. 789, 2-34-56, xx Town, yy City, zz Prefecture” from the memory section 36′ shown in FIG. 8 of the electronic money card EM2.

Then, the processing advances to step C4. At step C4, the terminal apparatus IN2 decides whither or not the delivery destination information D21 of the gift 30′ is acquired already. This decision is made after it is confirmed by the user that the delivery destination information D21 read out from the electronic money card EM2 may be used. If the delivery destination information D21 of the gift 30′ is acquired already, then the terminal apparatus IN2 advances the processing to step C5, at which it executes a settlement process regarding the acquisition of the gift 30′. The settlement process is executed, for example, by rewriting settlement information stored in the electronic money card EM2. In the present example, the year, month and day of utilization, utilization amount and balance are rewritten in the charging information describing area II illustrated in FIG. 8.

Thereafter, the terminal apparatus IN2 confirms at step C6 whether the settlement process is completed successfully. If the settlement process is completed in failure, then the processing advances to step C7, at which the terminal apparatus IN2 confirms whether or not another gift 30′ should be selected to attempt a settlement process. At this time, a message of “Do you select a gift 30′ to attempt a settlement process again?” is displayed on the display apparatus 45. On the display apparatus 45, icons of, for example, “continuation”, “suspension” and so forth are displayed in addition to the message given above. For example, if the user depresses the icon of “continuation”, that is, if a gift 30′ is to be selected to attempt a settlement process again, then the processing advances to step C8. At step C8, the terminal apparatus IN2 continues its control in response to re-selection of a gift 30′ by the user. After a gift 30′ is re-selected, the processing returns to step C5.

If it is decided at step C6 that the settlement process results in success as a result of execution of the settlement process at step C5, then the processing advances to step C9, at which the settlement information and the delivery destination information D21 are displayed on the display apparatus 45 so as to notify the user. After the settlement information and the delivery destination information D21 are displayed on the display apparatus 45, the processing advances to step C10, at which the terminal apparatus IN2 merges the delivery destination information D21 acquired by the information reading out process and the gift selection information D22 outputted from the inputting apparatus 42 in an associated relationship with each other to produce gift delivery information D2. Thereafter, the processing advances to step C11, at which the terminal apparatus IN2 notifies the web server WB2 or the like of the gift delivery information D2 which associates the delivery destination information D21 and the gift selection information D22 with each other.

It is to be noted that, if the user does not select any gift 30′ at step C2 described hereinabove, then the information processing procedure by the terminal apparatus IN2 is ended. Further, if an operation to stop selection of a gift 30′ is not performed by the user at step C7, for example, if the icon of “suspension” is depressed, then the terminal apparatus IN2 suspends the settlement process and ends the information processing procedure.

In this manner, with the electronic money card gift-giving system and the information processing method therefor according to the second example of the present invention, when a gift 30′ is to be selected and acquired from an online store, an operation by the gift-receiving party of inputting the address of its home or name can be omitted. Thus, the necessary operation can be reduced to an operation of passing or holding the electronic money card EM2 through or over the card communication apparatus CM2. Besides, the gift delivery center can deliver a gift 30′, selected by the user on the display apparatus 45 as a result of accessing to the web server WB2 or the like using the terminal apparatus IN2, to the address of the gift-receiving party, that is, to the delivery destination, based on the delivery destination information D21 added to the gift delivery information D2.

### THIRD EXAMPLE

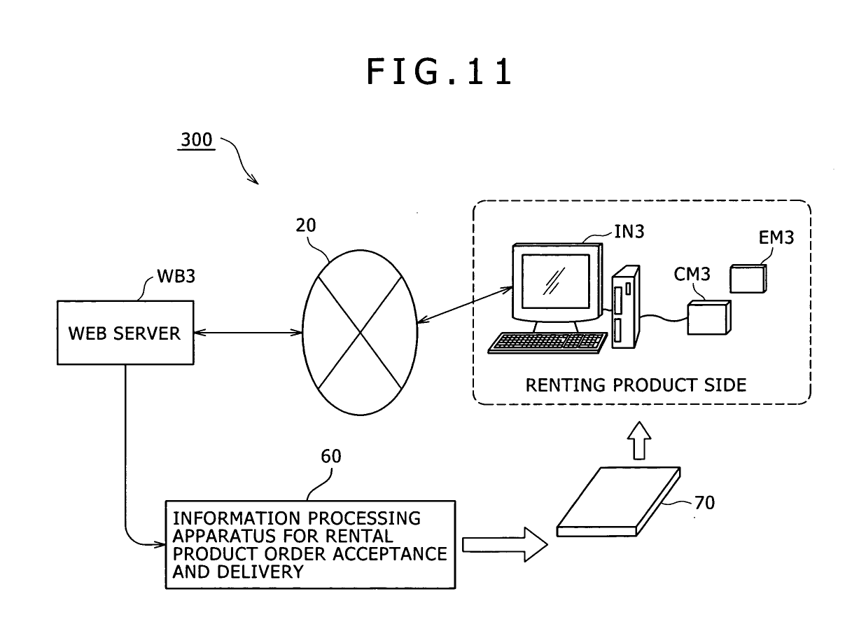

FIG. 11 shows an example of a configuration of an electronic money card utilization system according to a third example of the present invention.

In the present example, the electronic money card utilization system 300 is configured such that the delivery destination of a rental commodity is limited, and delivery destination information D31 of rental commodities 70 is registered in an electronic money card EM3. When a rental commodity 70 is to be rented, the delivery destination information D31 is read from the electronic money card EM3, and the rental commodity 70 is delivered to the address place based on the delivery destination information D31 registered in the electronic money card EM3.

The electronic money card utilization system 300 shown in FIG. 11 is a further form of the information processing system and processes rental commodity delivery information D3 generated in an online store which receives an order of a rental commodity 70 through the Internet 20 and delivers the rental commodity 70. The rental commodities 70 are recording media on or in which image information, music information or the like is recorded such as a DVD, a CD or an MD. The rental commodities 70 are not limited to those recording media but may have any form only if they can be lent. For example, the rental commodities 70 may be rental cars, rental bicycles or the like.

The electronic money card utilization system 300 applies the electronic money card utilization system 100 according to the first example and includes the web server WB3, terminal apparatus IN3, card communication apparatus CM3 and so forth extracted from the electronic money card utilization system 100.

In the electronic money card utilization system 300, the renting party side of rental commodities includes an electronic money card EM3 which is a form of a recording medium for a charging process such that the charge imposed on lending of a rental commodity 70 is settled. In the electronic money card utilization system 300, delivery destination information D31 is registered or recorded into the electronic money card EM3. The delivery destination information D31 is registered or recorded when or after the electronic money card EM3 is purchased.

For lending of a rental commodity, a recording apparatus is provided, for example, in an automatic card selling machine such that delivery destination information D31 which is address information of an electronic money card purchasing person indicative of the delivery destination of a rental commodity 70 is recorded into the electronic money card EM3. Naturally, recording into the electronic money card EM3 is not limited to this, but delivery destination information D31 may be recorded into the electronic money card EM3 when a rental commodity 70 is rented for the first time from an online store.

In the electronic money card utilization system 300, for the recording medium for a charging process, a portable telephone set EMm having a function equivalent to that of the electronic money card EM3 may be utilized in place of or in addition to the electronic money card EM3. A memory is provided in the portable telephone set EMm such that delivery destination information D31 is registered into the memory. Thus, when a rental commodity 70 to be lent from the online store is to be received, information may be communicated using an infrared communication apparatus, a short-distance radio communication function or the like.

In the electronic money card utilization system 300, the delivery destination information D31 registered in the electronic money card EM3 is read out by the card communication apparatus CM3 which has a function of a reading apparatus. Preferably, the card communication apparatus CM3 has an information writing function in addition to an information reading out function. This is because, when a rental commodity 70 is to be rented for the first time from the online store, the delivery destination information D31 can be recorded into the electronic money card EM3. Preferably, the card communication apparatus CM3 is provided for each Internet-connectable terminal. Also in the electronic money card utilization system 300, the delivery destination information D31 is read from the electronic money card EM3 by an operation of passing or holding up the electronic money card EM3 through or over the card communication apparatus CM3. Further, the portable telephone set EMm having an equivalent function reads the delivery destination information D31 in response to an operation of holding up the portable telephone set EMm over the card communication apparatus CM3.

For the card communication apparatus CM3, an information writing and reading out apparatus of the radio type or a radio transmission and reception apparatus of the infrared type is used. Thus, the card communication apparatus CM3 has a repeating function between the terminal apparatus IN3 and the electronic money card EM3, portable telephone set EMm shown in FIG. 1 or the like such that a communication process can be performed between the terminal apparatus IN3 and the electronic money card EM3, portable telephone set EMm or the like.

The Internet-connectable terminal apparatus IN3 having a function of an information processing apparatus for acceptance of an order for a rental commodity is connected to the card communication apparatus CM3 such that it accepts an order or selection of a rental commodity 70 to produce rental commodity selection information D32. The terminal apparatus IN3 has a function of establishing connection to the Internet 20 and functions of displaying rental commodity information, settlement information and so forth of an online store as a specialty store for rental commodities and outputting the rental commodity selection information D32.

For the terminal apparatus IN3, a personal computer of the notebook type, a personal computer of the desk top type, a television receiver having a communication function or a like apparatus is used. The terminal apparatus IN3 notifies the information processing system for rental commodity delivery and management of the rental commodity delivery information D3 which associates the delivery destination information D31 read by the card communication apparatus CM3 and the rental commodity selection information D32 with each other.

Meanwhile, the rental commodity lending party side includes a web server WB3 which forms an information distribution system. The web server WB3 provides display information for displaying an image, explanation, rental fee, method of payment and so forth of a rental commodity and distributes information necessary for lending of a rental commodity from an online store.

Further, the web server WB3 performs a shipment process of a rental commodity 70 if a charging process which is performed later results in success based on the delivery destination information D31 received from the terminal apparatus IN3 in response to the distribution of the necessary information. If the charging process results in NG, then the web server WB2 issues an urging notification to select another gift. For example, the web server WB3 transfers the rental commodity delivery information D3 received from the terminal apparatus IN3 to the information processing system for rental commodity delivery and management.

A plurality of such web servers WB3 on the rental commodity selling or lending party side and the terminal apparatus IN3 on the rental commodity renting party side are connected to each other by the Internet 20. The communication system in this instance includes, in addition to the Internet 20, a public telephone network and a dedicated communication network.

The rental commodity lending party side described above includes, for example, an information processing apparatus 60 for rental commodity order acceptance and delivery such that order acceptance and delivery of a rental commodity 70 are managed based on the rental commodity delivery information D3 transferred thereto from the web server WB3. The information processing apparatus 60 is formed, for example, from a personal computer and manages delivery of rental commodities 70 whose order is received. The information processing apparatus 60 is disposed in a rental commodity delivery center and delivers the rental commodities 70 to an address place based on the delivery destination information D31.

It is to be noted that description of the information processing method in the electronic money card utilization system 300 is omitted herein but it may be recognized by referring to the flow charts of FIGS. 5 and 6 illustrating operation of the electronic money card utilization system 100 described hereinabove. In this instance, the term “commodity” should be read as “rental commodity” and “card user” should be read as “debtor”.

With the electronic money card utilization system 300 according to the third example wherein the delivery destination of a rental commodity is limited in this manner, when a rental commodity 70 is to be rented from an online store, an operation by a rental commodity renting party of inputting the address of its home or name can be omitted. Thus, the necessary operation can be reduced to an operation of passing or holding the electronic money card EM3 through or over the card communication apparatus CM3. Besides, the rental commodity delivery center can deliver a rental commodity 70 to the delivery destination based on the delivery destination information D31 added to the commodity order acceptance information D1. Consequently, the electronic money card utilization system 300 can be configured such that the delivery destination of a rental commodity 70 is limited.

### FORTH EXAMPLE

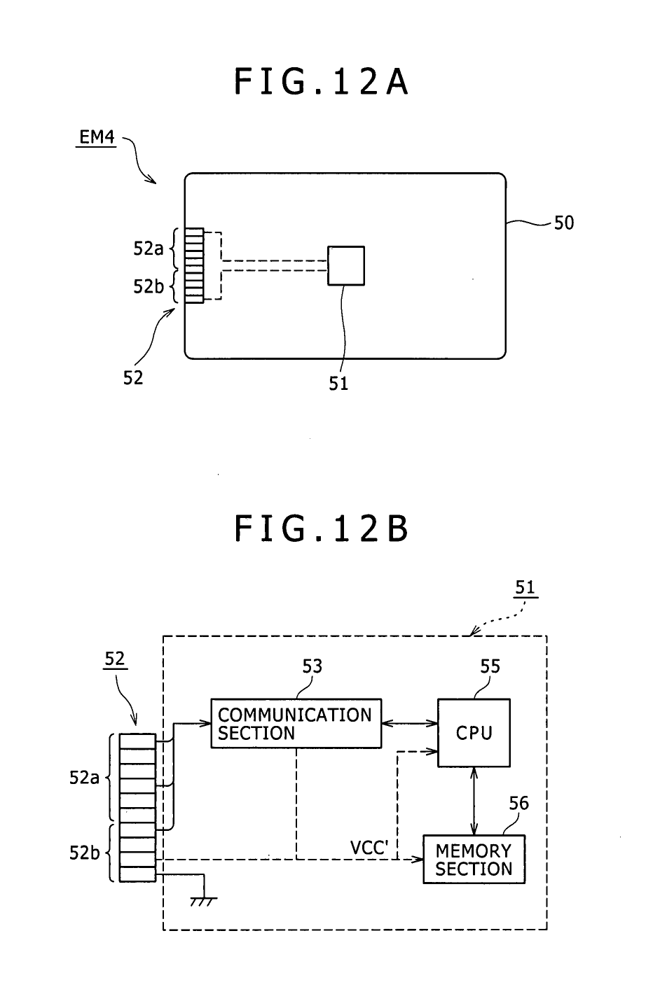

FIGS. 12A and 12B show an example of a configuration of an electronic money card EM4 according to a fourth example of the present invention.

In the present working example, the present invention is applied to the electronic money card EM4 of the contact type which can be applied to the electronic money card utilization systems 100 and 300 and the electronic money card gift-giving system 200 described hereinabove in connection with the first, third and second examples. In the present example, an electronic recording card medium (prepaid/postpaid card (tag), Edy card or the like) of the contact type for a charging process is used in place of the electronic money cards EM1 to EM3 of the contactless type described hereinabove in connection with the first to third working examples. Into the electronic recording card medium, delivery destination information D11, D21 or D31 is registered.

The electronic money card EM4 for a charging process shown in FIG. 12a has a function of a recording medium for settling a fee imposed on purchase of a commodity 30 or lending of a rental commodity 70 or for settling of a gift 30′ upon acquisition. In the electronic money card EM4, delivery destination information D11, D21 or D31 which is address information representative of a delivery destination of a commodity 30, gift 30′ or rental commodity 70 is recorded. When a commodity 30 is purchased, when a gift 30′ is selected and acquired or when a rental commodity 70 is rented, the delivery destination information D11, D21 or D31 is read from the electronic money card EM4.

The electronic money card EM4 has a card body portion 50 of a size similar to that of the electronic money card EMj in the first example and has a layered structure wherein an IC chip 51 is held by the card body portion 50. Since the electronic money card EM4 is of the contact type, it has terminals 52 for information inputting and outputting and for power supply. The terminals 52 are divided into information input and output terminals 52a and power supply terminals 52b.

FIG. 12B shows an example of an internal configuration of the IC chip 51 of the electronic money card EM4. Referring to FIG. 12B, the IC chip 51 includes a communication section 53, a CPU 55 and a memory section 56.

The information input and output terminals 52a shown in FIG. 12A are connected to the communication section 53. The communication section 53 connected to a signal input of the information input and output terminals 52a performs a communication process with a card communication apparatus not shown under the communication control of the CPU 55. For example, upon information writing, the communication section 53 receives delivery destination information D11, D21 or D31. Upon information reading out, the communication section 53 signals delivery destination information to a signal output of the information input and output terminals 52a.

The CPU 55 is connected to the communication section 53 such that, upon information writing or reading out, it controls inputting or outputting of the communication section 53, memory section 56 and so forth. For example, upon information reading out, delivery destination information D11, D21 or D31 read out from the memory section 56 is outputted to the communication section 53. Upon information writing, delivery destination information D11, D21 or D31 obtained from the communication section 53 is recorded into the memory section 56.

The memory section 56 is connected to the CPU 55 such that delivery destination information D11, D21 or D31, charging information or the like received by the communication section 53 is stored into the memory section 56 or control data for an information writing or reading out procedure or the like are stored into the memory section 56. For the memory section 56, a nonvolatile memory such as an EEPROM is used. Where a nonvolatile memory is used, even if the power supply is cut off, the delivery destination information D11, D21 or D31, charging information or the like is kept recorded in the memory section 56.

The electronic money card EM4 of the contact type receives power from the outside through the power supply terminals 52b. To the power supply terminals 52b, the communication section 53, CPU 55 and memory section 56 are connected. A dc voltage VCC′ is supplied from the power supply terminals 52b to the communication section 53, CPU 55 and memory section 56. To the electronic money card EM4 of the contact type, a card communication apparatus or a terminal apparatus INj having terminals for connecting to an electronic money card is applied such that dc power is supplied to the electronic money card EM4 through the power supply terminals 52b.

In this manner, with the electronic money card EM4 of the contact type according to the fourth example, when a commodity 30 is to be purchased, when a gift 30′ is to be acquired or when a rental commodity 70 is to be rented, from an online store, the electronic money card EM4 of the contact type is loaded into a card communication apparatus or a terminal apparatus INj which has the terminals for connecting to an electronic money card.

Accordingly, an operation, by a commodity purchasing party, a gift-acquiring party, a rental commodity renting party or the like, of inputting the address of its name or home can be omitted. Thus, the necessary operation can be reduced to an operation of loading an electronic money card into the card communication apparatus. Besides, the commodity delivery center, gift delivery center or rental commodity delivery center can deliver a commodity 30, a gift 30′ or a rental commodity 70 to the delivery destination based on the delivery destination information D11, D21 or D31 added to the commodity order acceptance information D1, gift delivery information D2, rental commodity order acceptance information D1 or the like. Consequently, even where the electronic money card EM4 of the contact type is used, the electronic money card utilization system 100 or 300 or the electronic money card gift-giving system 200 can be constructed. By constructing such systems 100 to 300, the electronic money cards EM1 to EMj of the contactless type or/and the contact type can be popularized, which contributes much to development of the industry.

The present invention can be applied very suitably to an electronic money card utilization system wherein the delivery destination of a commodity is limited, to an electronic money card gift-giving system wherein the delivery destination of a gift is limited and to an electronic money card utilization system wherein the delivery destination of a rental commodity is limited.

While a preferred embodiment of the present invention has been described using specific terms, such description is for illustrative purpose only, and it is to be understood that changes and variations may be made without departing from the spirit or scope of the following claims.

What is claimed is:

1. A recording medium for a charging process for settling a charge imposed on purchase or lending of a commodity, wherein
said recording medium has recorded thereon delivery destination information which indicates a delivery destination of the commodity and is read from said recording medium when the commodity is purchased or rented.

2. The recording medium according to claim 1, wherein an electronic money card of the contact type or the contactless type is used for said recording medium.

3. An information processing system for processing commodity order acceptance information generated in an online store from which a commodity is to be purchased or lent through a communication system, comprising:
a recording medium for a charging process configured to settle a charge imposed on purchase or lending of the commodity;
a recording apparatus configured to record delivery destination information indicative of a delivery destination of the commodity into said recording medium;
a reading apparatus configured to read the delivery destination information from said recording medium; and
an information processing apparatus for commodity order acceptance connected to said reading apparatus and configured to accept an order or selection of the commodity to generate commodity order acceptance information;
said information processing apparatus notifying an information processing apparatus for commodity order acceptance and delivery of commodity order acceptance information by which the delivery destination information read by said reading apparatus and commodity selection information obtained by the acceptance of the order or selection of the commodity are associated with each other.

4. The information processing system according to claim 3, wherein an electronic money card of the contact type or the contactless type is used for said recording medium.

5. The information processing system according to claim 3, wherein a portable telephone set is used for said recording medium.

6. An information processing method for processing commodity order acceptance information generated in an online store from which a commodity is to be purchased or lent through a communication system, comprising:
a step of recording delivery destination information indicative of a delivery destination of the commodity into a recording medium for a charging process for settling a charge imposed on purchase or lending of the commodity; and
steps, executed upon purchase or lending of the commodity, of:
reading the delivery destination information from the recording medium;
accepting an order or selection of the commodity and acquiring commodity selection information;
associating the delivery destination information read from the recording medium and the acquired commodity selection information with each other; and
notifying an information processing system for commodity order acceptance and delivery of commodity order acceptance information by which the delivery destination information and the commodity selection information are associated with each other.

7. The information processing method according to claim 6, wherein an electronic money card of the contact type or the contactless type is used for the recording medium.

8. The information processing method according to claim 6, wherein a portable telephone set is used for said recording medium.
